(19) United States
(12) Patent Application Publication
(10) Pub. No.: US 2010/0239710 A1
(43) Pub. Date: Sep. 23, 2010

(54) COFFEE PRODUCT AND METHOD

(75) Inventors: Cynthia Cary, Benton, KY (US); Saundra Keeling, Benton, KY (US)

Correspondence Address: HUSCH BLACKWELL SANDERS LLP, 190 Carondelet Plaza, Suite 600, ST. LOUIS, MO, 63105, US

(73) Assignee: EMPTY NEST IDEAS LLC, Benton, KY (US)

(21) Appl. No.: 12/766,042

(22) Filed: Apr. 23, 2010

Related U.S. Application Data
(63) Continuation-in-part of application No. 12/408,237, filed on Mar. 20, 2009.

(51) Int. Cl. A23F 5/10

(52) U.S. Cl. 426/2; 426/93

(57) ABSTRACT

A coffee pill and method are provided. The coffee pill includes decaffeinated coffee encapsulated to prevent contact of the coffee product with the pallet during the initial stage of consumption by oral ingestion. Upon reaching the digestive tract, the encapsulant dissolves permitting the decaffeinated coffee product to be released from the pill.

### RELATED APPLICATIONS

This application is a continuation-in-part of non-provisional patent application Ser. No. 12/408,237 filed Mar. 20, 2009, the entire disclosure of which is incorporated herein by reference.

### BACKGROUND OF THE INVENTION

The consumption of coffee and coffee containing products is well known. Consumption is generally in the form of ingesting a brewed beverage which can be made from one of many varieties of coffee and can be ground roasted coffee or instant coffee. Coffee is also added to food products as an ingredient, usually as a flavorant permitting sensing of taste once the product reaches the mouth. Even some candies include coffee including whole roasted coffee beans. Coffee is processed prior to consumption, usually first by roasting the beans and then grinding the same. The coffee may also be decaffeinated coffee and some decaffeinated coffee is likewise made into instant coffee.

One of the benefits of consuming coffee is the intake of caffeine. However, many people do not like the taste of coffee but desire the caffeine and the temporary stimulation it provides. Robusta coffee, even though less expensive and higher in caffeine, has an even less liked taste. Additionally, many people who like coffee and the caffeine are not always at a place or at a time that coffee can be consumed in its normal form as a hot or even cold beverage.

Consuming coffee also provides health benefits unrelated to caffeine. Coffee contains antioxidants and other health promoting compounds. Indeed, recent studies indicate that consuming coffee can reduce the risk of Type 2 Diabetes, Parkinson's Disease, asthma and some forms of cancer. Further, many of the beneficial ingredients of coffee are likewise found in decaffeinated coffee. Thus, many people who want the health benefits of coffee, but who do not want the temporary stimulation provided by caffeine, can consume coffee products that have been decaffeinated. According to the International Standard, coffee which has at least 97% of the caffeine in the beans removed can be called “decaffeinated”. According to the European Union Standard, decaffeinated coffee must be 99.9% caffeine-free by mass.

There is therefore a need for a way to consume coffee and its caffeine, avoid the taste and not have to brew a beverage with the resultant problems attendant with brewing and consuming a hot beverage. It is also desirable to consume coffee to obtain any health benefits from coffee—either caffeinated or decaffeinated—while avoiding brewing and objectionable taste.

### SUMMARY OF INVENTION

The present invention involves the provision of a decaffeinated coffee product that may be ingested in a convenient dry form to avoid the taste of the coffee and/or to gain whatever health benefits are provided by consuming coffee. The consumption of dry coffee avoids the necessity of having to have an apparatus for brewing the coffee, a cup and/or a hot water source to make the typical coffee beverage.

### DESCRIPTION OF THE DRAWINGS

FIG. 1 is a fragmentary side elevation and view of a coffee pill utilizing coffee particulates in a capsule.

FIG. 2 is an exploded view of the pill of FIG. 1.

FIG. 3 is a fragmentary side elevation view of a coffee pill utilizing coffee particulates formed into a solid tablet.

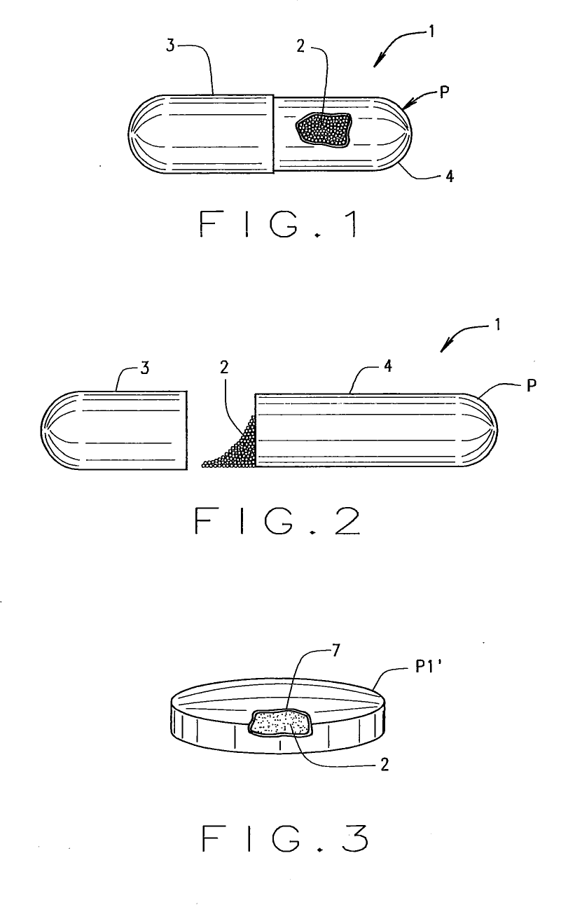

### DETAILED DESCRIPTION

The present invention relates to a coffee product in pill form. In a preferred embodiment, the pill P includes a capsule 1 which contains a particulate coffee product 2 inside the capsule to form a pill P. Preferably, the capsule 1 has two portions 3, 4 and is soluble after ingestion to release the coffee product 2 contained in the capsule 1. The capsule 1 encapsulates the coffee product 2. The contained coffee product 2 is released after the pill P has passed through the oral cavity. Preferably, the capsule 1 is of the size 00 or smaller and may be made of a soluble material such as gelatin. The capsule 1 may be vegetable (e.g. methylcellulose or spun protein) as well as animal based and may be flavored if desired. Such capsules typically come in two parts 3, 4 and can be filled with a dry particulate coffee (regular or instant). Particulate coffee powder is known in the art and can be instant coffee or ground coffee (roasted or unroasted). Preferably, each capsule 1 will contain in the range of between about 0.2 grams and about 0.4 grams of coffee product 2 and at least about 20 milligrams of caffeine per pill P. When utilizing uncompressed coffee, it has been found that a dosage of approximately one teaspoon of finely powdered instant coffee can be delivered in four 00 size capsules which is equivalent to about one cup of coffee. Preferably, the coffee product 2 is instantized water soluble coffee. Preferably the coffee product 2 is finely ground.

In the alternative, each capsule 1 may contain coffee product 2 which is decaffeinated. In this embodiment, coffee product 2 would preferably contain less than 3% of the caffeine originally contained in the coffee beans used to create coffee product 2, so as to be “decaffeinated” under the International Standard. More preferably, coffee product 2 would be at least 99.9% caffeine-free by mass, so as to be “decaffeinated” under the European Union Standard.

The coffee product 2 may also be pressure formed to form a solid tablet of the particulates by using suitable binders and a suitable pressure forming method as are known in the art. The pressure formed material may be delivered in a soluble capsule or may be a tablet coated (encapsulated) with a soluble coating material 7 to prevent coffee in the pill P′ of FIG. 3 from dissolving for a period of time adequate to permit swallowing while avoiding the taste of the coffee product 2.

It is has been found that, by use of the present invention, Robusta coffee—either caffeinated or decaffeinated—can be utilized while avoiding its objectionable taste. Robusta coffee typically has a much higher caffeine content than other types of coffee and is less expensive. If one is desirous of a higher concentration of caffeine, Robusta would be a coffee of choice except for its taste. Alternatively, decaffeinated Robusta could be used. Preferably, the coffee product 2 includes at least a majority by weight Robusta derived coffee product. The present invention allows for the consumption of Robusta coffee while avoiding its objectionable taste. Additionally, if higher concentrations of caffeine are desirable, caffeine can be added to the coffee product 2 which could reduce the number of pills needed to be consumed to get to the desired amount of caffeine. It is also recognized and anticipated that other types, varieties, and/or brands of coffee, other than Robusta, including caffeinated, decaffeinated, regular, instant, roasted, and/or unroasted could likewise be used to form the present coffee product.

By use of the present invention, the consumption of the coffee product 2 avoids staining of the teeth, clothing, countertops and the beverage container used to serve a typical coffee product. The present invention also provides a way of consuming coffee that avoids the taste particularly of objectionable coffee varieties like Robusta as well as avoiding coffee breath. The present invention can be used at any time, anywhere, requires no liquid or heating device to brew a beverage, and prevents burning of the consumer in the event that a hot coffee beverage is spilled. The present invention also provides some of the positive benefits of antioxidants with or without the ingestion of caffeine. There are studies suggesting health benefits for coffee including a reduction in the risk of developing Type 2 Diabetes, Parkinson's disease, asthma and some forms of cancer.

The present invention provides a coffee product in a convenient pill form allowing the consumption of the coffee product at any time with no taste or requiring the use of water and a container to consume. Preferably, a pill of the coffee product 2 provides coffee in weight range on a dry weight basis, in the range of between about 0.2 grams and about 0.4 grams and preferably in the range of between about 0.25 grams and about 0.35 grams of coffee product per tablet. Caffeine is preferably present in a pill P, P′ in an amount of at least about 20 milligrams and more preferably at least about 25 milligrams of naturally present caffeine. Alternatively, coffee product 2 may be a decaffeinated coffee product preferably containing less than 3% of the caffeine originally contained in the coffee beans used to create coffee product 2. More preferably, the decaffeinated coffee product 2 may be at least 99.9% caffeine-free by mass.

The method of the present invention involves the ingestion of a coffee product 2 in dry encapsulated form which retards dissolution of the encapsulant (capsule 1, coating 7) during normal consumption prior to the tablet reaching the digestive tract of the consumer. Preferably, the pill P, P′ is provided in a form that keeps all the coffee encapsulated prior to reaching the digestive tract by the pill having a capsule or coating that is at least substantially imperforate at the start and initial stage of ingestion.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An ingestible pill of coffee product comprising:
decaffeinated ground coffee product; and
a soluble substantially imperforate encapsulant enclosing the coffee product.

2. The coffee product of claim 1 wherein the ground coffee is in an amount of between about 0.2 grams and about 0.4 grams.

3. The coffee product of claim 1 wherein the encapsulant includes a soluble capsule.

4. The coffee product of claim 1 wherein the decaffeinated coffee product is in tablet form and the encapsulant includes a soluble coating on the tablet.

5. The coffee product of claim 1 wherein the decaffeinated coffee product includes Robusta coffee.

6. The coffee product of claim 1 wherein the decaffeinated coffee product includes instant coffee.

7. The coffee product of claim 1 wherein the decaffeinated coffee product includes roasted coffee.

8. The coffee product of claim 1 wherein the decaffeinated coffee product meets the International Standard for caffeine content in decaffeinated coffee.

9. The coffee product of claim 8 wherein the decaffeinated coffee product contains less than about 3% of the caffeine present in the coffee beans used to make the decaffeinated coffee product.

10. The coffee product of claim 1 wherein the decaffeinated coffee product meets the European Union Standard for caffeine content in decaffeinated coffee.

11. The coffee product of claim 10 wherein the decaffeinated coffee product contains less than approximately 0.1% caffeine by mass.

12. A method of consuming a decaffeinated coffee product by a human, the method including:
providing a pill of decaffeinated coffee product and a substantially imperforate encapsulant enclosing the coffee product; and
ingesting the pill.

13. The method of claim 12 wherein the decaffeinated coffee product is in particle form and the encapsulant includes a soluble capsule.

14. The method of claim 13 wherein the decaffeinated coffee product includes instant coffee.

15. The method of claim 12 wherein the decaffeinated coffee product is in tablet form and the encapsulant includes a soluble coating on the tablet.

16. The method of claim 12 wherein the decaffeinated coffee product includes at least a majority Robusta derived coffee product.

17. The method of claim 12, wherein the decaffeinated coffee product meets the International Standard for caffeine content in decaffeinated coffee.

18. The coffee product of claim 17 wherein the decaffeinated coffee product contains less than about 3% of the caffeine present in the coffee beans used to make the decaffeinated coffee product.

19. The coffee product of claim 12 wherein the decaffeinated coffee product meets the European Union Standard for caffeine content in decaffeinated coffee.

20. The coffee product of claim 19 wherein the decaffeinated coffee product contains less than approximately 0.1% caffeine by mass.
